(19) United States
(12) Patent Application Publication
(10) Pub. No.: US 2026/0133867 A1
(43) Pub. Date: May 14, 2026

(54) DEFECT NAVIGATOR SYSTEM AND METHOD FOR DISTRIBUTED CLOUD-NATIVE DEVELOPMENT

(71) Applicant: DISH Network Technologies India Private Limited, Bangalore (IN)

(72) Inventors: Vimalraj Ganesan, Bengalura (IN); Deepak Sharma, Bengaluru (IN)

(21) Appl. No.: 18/942,252

(22) Filed: Nov. 8, 2024

(51) Int. Cl. G06F 11/07

(52) U.S. Cl. CPC G06F 11/079; G06F 11/0787

(57) ABSTRACT

A method of defect navigation of a logging system is shown. A method includes: detecting critical log errors in examined incoming logs; categorizing failures associated with the detected critical log errors by revealing underlying patterns associated with the detected critical log errors; identifying use cases related to the categorized failures using root cause analysis of the underlying patterns; identifying specific user sets with a high probability of encountering other use cases that correlate with the identified use cases; dynamically adjusting log levels for the specific user sets with a high probability of encountering the other use cases, based on the detected critical errors and the categorized failures; initiating a learning phase that employs a feedback loop and monitors system performance; dynamically adjusting a duration of the learning phase based on a rate of change in user behavior; and in response to completing the learning phase, dynamically adjusting log levels.

### BACKGROUND

In the existing system, multiple microservices utilize logger libraries to record logs at various levels, such as info, debug, error, panic, and the like. These logs are typically stored in different repositories, including file databases, log cost-effective S3 storages, or data lakes. The logging configurations are statically controlled using predefined settings, allowing developers to manage the verbosity of logs by adjusting configuration parameters. While this setup provides essential logging capabilities, it lacks adaptability and may lead to challenges such as high logging costs, insufficient log detail for effective debugging and manual effort to analyze the long set of logs.

Accordingly, there is a continuing need for a system that can analyze microservice based applications and provide useful feedback. The present disclosure addresses this and other needs.

### BRIEF SUMMARY

The present disclosure relates generally to cloud-native networks, more particularly, to a system for automatic analysis of defects by fetching cost-efficient auto-controlled logs method for problematic use cases.

Briefly stated, one or more embodiments of a defect navigator method of a logging system in distributed cloud-native development are disclosed. Some such methods include: continuously examining, via a defect log analyzer, incoming logs to detect anomalies and failures based on predefined and dynamically learned markers; detecting, via the defect log analyzer, critical log errors in the examined incoming logs; categorizing failures associated with the detected critical log errors, via a defect use case identifier, by revealing underlying patterns associated with the detected critical log errors; identifying, via the defect use case identifier, use cases related to the categorized failures using root cause analysis of the underlying patterns, wherein the use cases are associated with user sets; identifying, via a defect similar user set system, specific user sets with a high probability of encountering other use cases that correlate with the identified use cases; optimizing resource usage by targeting the specific user sets for more detailed logging and analysis; dynamically adjusting, via a defect log level controller, log levels for the specific user sets with the high probability of encountering the other use cases, based on the detected critical errors and the categorized failures; in response to identified failure use cases, initiating a learning phase during which a trained understanding of user behavior is refined by the logging system using a feedback loop that monitors system performance; dynamically adjusting, via a defect learning period manager, a duration of the learning phase based on a rate of change in user behavior; and in response to accumulating a predetermined volume of user logs across log levels and completing the learning phase, dynamically adjusting log levels to refine system configuration, minimize resource usage, and retain critical log information for effective debugging and system monitoring.

In one or more embodiments of the defect navigator method, the defect log analyzer logs critical events that capture insights and stores the critical events in a database. In another aspect of some embodiments, the stored critical events are used to generate a defect summary report that provides detailed characteristics and associated intelligent events for in-depth automatic bug analysis. In still another aspect of some embodiments, the defect navigator method further includes: strategically enabling detailed logging for specific user sets and temporal intervals. In yet another aspect of some embodiments, the defect navigator method further includes: using cloud-native logging to provide scalable and adaptive solutions for log management in distributed environments.

In some embodiments of the defect navigator method, the dynamically adjusted log levels provide resource automatized logging. In another aspect of some embodiments, the defect log analyzer captures detailed information about specific errors encountered by different users. In still another aspect of some embodiments, the defect use case identifier segregates users based on one or more attributes including user type, location, channel type, and error type. In yet another aspect of some embodiments, the defect learning period manager examines feedback on use case predictions and uses the feedback to refine and improve prediction algorithms.

In other embodiments, a system for defect navigation of a logging system is disclosed. The system includes a memory that stores computer-executable instructions; and a processor that executes the computer-executable instructions that cause the processor to: detect critical log errors in examined incoming logs; categorize failures associated with the detected critical log errors by revealing underlying patterns associated with the detected critical log errors; identify use cases related to the categorized failures using root cause analysis of the underlying patterns, wherein the use cases are associated with user sets; identify specific user sets with a high probability of encountering other use cases that correlate with the identified use cases; dynamically adjust log levels for the specific user sets with the high probability of encountering the other use cases, based on the detected critical errors and the categorized failures; in response to identified failure use cases, initiate a learning phase that includes training on user behavior and use a feedback loop that monitors system performance; dynamically adjust a duration of the learning phase based on a rate of change in user behavior; and in response to completing the learning phase, dynamically adjust log levels to refine system configuration.

In one or more embodiments of the system for defect navigation of a logging system, the system logs critical events that capture insights and stores the critical events in a database. In another aspect of some embodiments, the stored critical events are used to generate a defect summary report that provides detailed characteristics and associated intelligent events for in-depth automatic bug analysis. In still another aspect of some embodiments, the system strategically enables detailed logging for specific user sets and temporal intervals. In yet another aspect of some embodiments, the system uses cloud-native logging to provide scalable and adaptive solutions for log management in distributed environments.

In some embodiments of the system for defect navigation of a logging system, the system dynamically adjusts log levels to provide resource automatized logging. In another aspect of some embodiments, the system captures detailed information about specific errors encountered by different users. In still another aspect of some embodiments, the system segregates users based on one or more attributes including user type, location, channel type, and error type. In yet another aspect of some embodiments, the system examines feedback on use case predictions and uses the feedback to refine and improve prediction algorithms.

Moreover, in still other embodiments, a method for defect navigation of a logging system is disclosed. The method includes: detecting critical log errors in examined incoming logs; categorizing failures associated with the detected critical log errors by revealing underlying patterns associated with the detected critical log errors; identifying use cases related to the categorized failures using root cause analysis of the underlying patterns, wherein the use cases are associated with user sets; identifying specific user sets with a high probability of encountering other use cases that correlate with the identified use cases; dynamically adjusting log levels for the specific user sets with a high probability of encountering the other use cases, based on the detected critical errors and the categorized failures; initiating a learning phase that employs a feedback loop and monitors system performance; dynamically adjusting a duration of the learning phase based on a rate of change in user behavior; and in response to completing the learning phase, dynamically adjusting log levels.

In one or more embodiments, the defect navigator method logs critical events that capture insights and stores the critical events in a database. In another aspect of some embodiments, the stored critical events are used to generate a defect summary report that provides detailed characteristics and associated intelligent events for in-depth automatic bug analysis. In still another aspect of some embodiments, the defect navigator method further includes: strategically enabling detailed logging for specific user sets and temporal intervals. In yet another aspect of some embodiments, the defect navigator method further includes: using cloud-native logging to provide scalable and adaptive solutions for log management in distributed environments.

In some embodiments of the defect navigator method, the dynamically adjusted log levels provide resource automatized logging. In another aspect of some embodiments, the defect navigator method captures detailed information about specific errors encountered by different users. In still another aspect of some embodiments, the defect use case identifier segregates users based on one or more attributes including user type, location, channel type, and error type. In yet another aspect of some embodiments, the defect learning period manager examines feedback on use case predictions and uses the feedback to refine and improve prediction algorithms.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the disclosed invention, reference will be made to the following Detailed Description, which is to be read in association with the accompanying drawings.

FIG. 1 illustrates a logic diagram of a defect navigator system for a logging system in a distributed cloud-native development, which may be implemented in accordance with embodiments described herein.

FIG. 2 is a logic diagram showing a defect navigator system for Program Blackout During Live Broadcast use case.

FIG. 3 is a logic diagram showing a defect navigator system for Stream Start Latency Spikes use case.

FIG. 4 is a logic diagram showing a defect navigator system for Pod Reboot Due to Memory Leak use case.

FIG. 5 is a logic diagram showing a defect navigator system for Multi-Step Filtering and Exclusion Process use case.

FIG. 6 is a logic diagram showing a method of using defect navigator for distributed cloud-native development.

FIG. 7 shows a system diagram that describes an example implementation of a computing system(s) for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

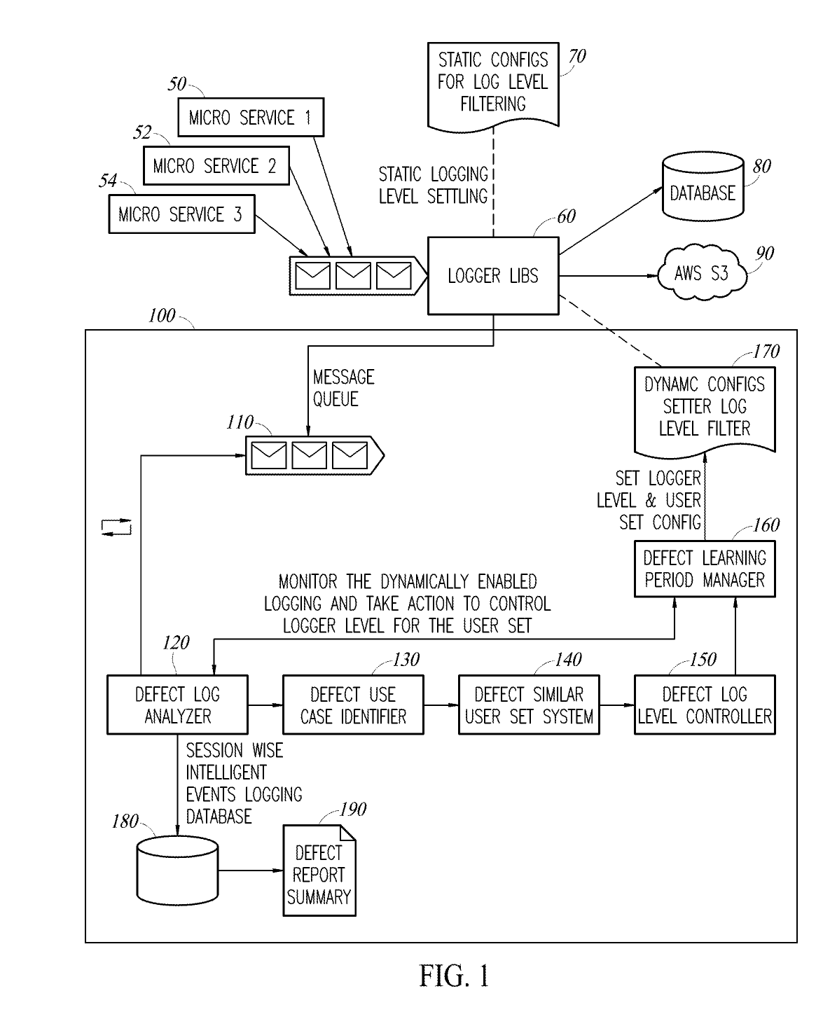

In some embodiments of the present disclosure, which are set within the dynamic landscape of a distributed cloud-native development, a defect navigation technique is implemented to dynamically control logging mechanisms and defect analysis. The defect navigator system for a logging system in a distributed cloud-native development 100 goes beyond traditional log level adjustments, and incorporates the creation of intelligent events by using its defect log analyzer during fault events. The defect navigator system for a logging system in a distributed cloud-native development 100 combines real-time fault detection with post-analysis capabilities, as well as enriching the system’s ability to ensure reliability and performance in the distributed cloud-native environment. The defect navigator system 100 represents a pioneering solution for robust defect identification, analysis, and continuous improvement in cloud-native systems, which will be further described below with reference to FIG. 1-7.

FIGS. 1-7 illustrate various aspects of an environment that is described below with respect to a defect navigator system for a logging system in a distributed cloud-native development 100. For example, FIG. 1 illustrates a context diagram of the architecture and connection of various components of the defect navigator system 100. As discussed above, in existing systems, multiple microservices 50, 52, 54 utilize logger libraries 60 to record logs at various levels, such as info, debug, error, panic, and the like. Such a legacy system may also include static configuration for log level filtering 70. These logs are typically stored in different repositories, including one or more of file databases 80, AWS S3 storages 90, or data lakes (not shown).

In one or more embodiments, the components of the defect navigator system 100 include a message queue 110, a defect log analyzer 120, a defect use case identifier 130, a defect similar user set system 140, a defect log level controller 150, a defect learning period manager 160, and a dynamic configuration setter log level filter 170. Referring now to the message queue 110, this component is configured to receive the record logs from the logger libraries 60, which the logger libraries 60 in turn collected from various microservices 50, 52, 54. The message queue 110 communicates with the defect log analyzer 120.

In one or more embodiments of the defect navigator system 100, the defect log analyzer 120 sifts through the incoming logs from the message queue 110, and selectively identifies critical errors. In some embodiments, the defect log analyzer 120 continuously monitors incoming logs. The defect log analyzer 120 detects anomalies and failures in real time, based on the pre-set markers and the learned markers. Additionally, the defect log analyzer 120 captures detailed information about the specific errors encountered by different users. After identifying the critical errors from the incoming logs, the defect log analyzer 120 subsequently forwards the information regarding the critical errors to the defect use case identifier 130.

In some embodiments, the defect use case identifier 130 categorizes failures, unveils underlying patterns, and identifies common use cases related to the failure. In another aspect, the defect use case identifier 130 analyzes the logs collected by the defect log analyzer 120 to identify patterns and relationships between failures. The defect use case identifier 130 segregates users based on various attributes, such as user type (e.g., paid/free), location, channel type, and error type/API. Additionally, the defect use case identifier 130 determines the root causes of the anomalies and failures using Root Cause Analysis (RCA) to identify the specific conditions that lead to the issue. This information is then communicated to the defect similar user set system 140.

In some embodiments of the defect navigator system 100, the defect similar user set system 140 is a core component of system workflow. For example, the defect similar user set system 140 leverages the insights from the previous stages, including by way of example only, and not by way of limitation, failure categorizations, underlying pattern recognition, and common use case failure identification, and the like. Using this information, the defect similar user set system 140, then identifies other sets of users with a high probability of encountering other use cases that correlate with the identified use cases to the previously identified sets of users based on the analysis provided by the defect use case identifier 130. In this manner, the defect similar user set system 140 targets specific user sets for more detailed logging and analysis, thereby optimizing resource usage. Next, the defect similar user set system 140 communicates this information to the defect log level controller 150.

In one or more embodiments of the defect navigator system 100, the defect log level controller 150 analyzes the collective behaviors of these user sets from the defect use case identifier 130 and the defect similar user set system 140. Then, the defect log level controller 150 dynamically instructs the log level adjustment for improvements in targeted and efficient logging. Additionally, the defect log level controller 150 exhibits resource optimization by strategically enabling detailed logging for specific user sets and temporal intervals, thereby yielding substantial operational efficiencies. By limiting the detailed logging to specific user sets and to specific temporal intervals, significantly enhanced operational efficiencies through resource optimization. Accordingly, the defect log level controller 150 ensures that the logs are detailed enough to capture necessary debugging information without overwhelming the system or incurring unnecessary infrastructure costs.

The innovative approach ensures comprehensive logs by dynamically adapting log levels based on the detection of critical errors and the categorization of failures, without compromising on the quality of debugging information. In this regard, the defect navigator system 100 creates a paradigm shift in cloud-native logging, and offers a scalable and adaptive solution for efficient log management in distributed environments. Additionally, the defect log level controller 150 communicates this information to the defect learning period manager 160.

In some embodiments of the defect navigator system 100, the defect learning period manager 160 orchestrates the learning phases of the workflow that enable the system to adapt its log level adjustments over time. The defect learning period manager 160 adapts its logging strategy based on real-time data. In this regard, the defect learning period manager 160 initiates controlled periods during which the system refines its modeling of user behavior and adjusts log levels, in response to identified failure use cases, in coordination with the defect log analyzer 120. Notably, the defect learning period manager 160 monitors system performance, establishes a feedback loop, and dynamically adjusts the duration of learning phases based on the rate of change in user behavior. In this manner, the defect learning period manager 160 monitors system performance and feedback loops to determine the duration of these learning periods and decides when to reset log levels to a more efficient configuration.

In one or more embodiments, once the defect learning period manager 160 accumulates a satisfactory volume of user logs across all log levels, the defect learning period manager 160 determines that it has met its learning objectives. At this point, the defect learning period manager 160 then initiates a reset of log configurations. In this regard, the defect learning period manager 160 ensures continuous improvement by adjusting the system behavior in response to evolving conditions. This reset of log configurations is facilitated by the dynamic configuration setter log level filter 170.

Notably, the defect learning period manager 160 achieves feedback-driven accuracy enhancement by incorporating feedback on the accuracy of use case predictions by collecting accuracy percentages after issue resolution. This feedback is used to refine and improve the prediction algorithms for future use cases. Additionally, the defect learning period manager 160 also incorporates an automated reporting and feedback loop that automatically generates detailed reports (e.g., Jira tickets), that include comprehensive information on the issue, use case, logs, and statistical summaries (e.g., number of affected users and potential future impact). In some embodiments, engineering feedback is integrated into the learning module to enhance future predictions and analysis.

In this manner, the dynamic configuration setter log level filter 170 dynamically adjusts log levels to a critical setting. This strategic and dynamic adjustment ensures that, after the comprehensive learning phase is completed, using the defect learning period manager 160, the logging system optimally refines its logging configuration. Additionally, the dynamic configuration setter log level filter 170 minimizes resource usage (e.g., limiting to specific user sets and temporal intervals), while still retaining sufficient log information essential for effective debugging and system monitoring.

At the same time that the defect log analyzer 120 is interacting with the defect use case identifier 130, the defect log analyzer 120 is also logging critical events that capture nuanced insights and are intelligently stored in the session wise intelligent events logging database 180. The culmination of this data that is intelligently stored in session wise intelligent events logging database 180 serves as the foundation for generating a comprehensive defect summary report 190. This defect summary report 190 not only offers a consolidated view of defects but also provides detailed characteristics and associated intelligent events for in-depth automatic bug analysis.

Referring now to the integration of the client-backend-service ecosystem, the defect navigator system for a logging system in a distributed cloud-native development 100 is designed to work across a diverse ecosystem, including client applications, backend services, upstream services (e.g., content management systems, DVRs, ML services), and multiple backend services. This comprehensive integration enables the logger libraries to receive input from various sources, providing a holistic view of user activity and system behavior. By comprehending the broader context of user interactions and service performance, the defect navigator system for a logging system in a distributed cloud-native development 100 is able to more accurately identify the root causes of issues and optimize logging across the entire ecosystem.

Referring again to the defect log analyzer 120 of the defect navigator system 100, the defect log analyzer 120 initiates defect analysis by identifying and prioritizing important logs across different modules. In some embodiments, this process uses input markers, which are specific log identifiers that signal potential issues or alarm conditions. Initially, these input markers are manually fed into the defect navigator system 100, and include common indicators such as “error,” “fatal,” “panic,” “pod restart,” “multiple request retry,” “request timeout,” “security risks,” “playback failure errors,” “buffering,” and “high latency.” Additionally, inputs from live alert systems, such as PagerDuty alerts, are also used to trigger the analysis process.

As the system evolves, the defect log analyzer 120 continually learns from past incidents and begins to autonomously identify new markers that may signify important events or failures. For example, in one embodiment, one or more input markers such as: “database connection errors,” “API rate limit exceeded,” “disk space low,” “unusual CPU or memory spikes,” “unexpected service downtimes,” and “failed authentication attempts” are automatically recognized and added to the system’s analysis criteria. This adaptive approach of the defect navigator system 100 ensures that the defect log analyzer 120 is responsive to emerging patterns and anomalies, thereby enabling the defect log analyzer 120 to detect and analyze defects more accurately and comprehensively as the system grows and evolves.

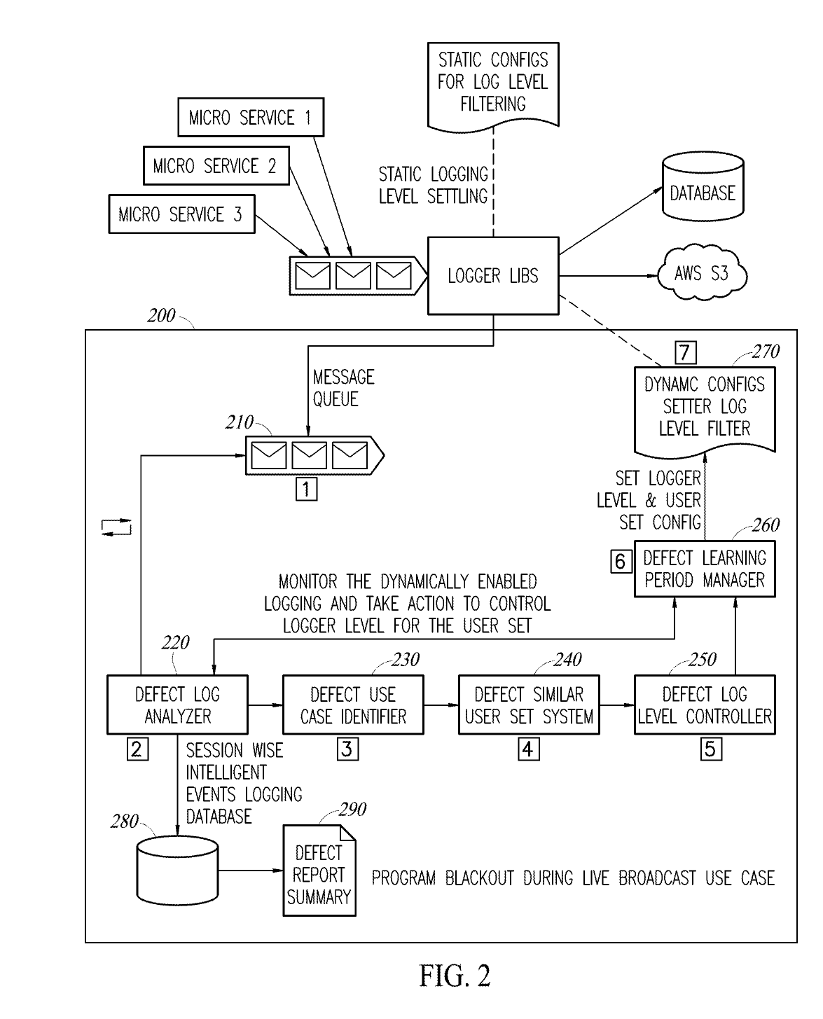

As shown in FIG. 2, in some embodiments the defect navigator system 200 is used to address the scenario of a Program Blackout During Live Broadcast. A live broadcast program may be blacked out for specific users based on their zip code or DMA (Designated Market Area). In this situation, a backend service needs to prevent the program from being listed on the application. If the program is listed and the user attempts to play the blacked out program, a playback failure occurs. This leads to various problematic experience for users, as well as burden on the system network. The operations and workflow of each system component are discussed below.

Initially, the message queue 210 of the defect navigator system 200 stores logs from all microservices, clients, and upstream components, such as machine learning engines, metadata services, and DVRs. These logs are added to the media stream by logger libs for offline analysis.

Referring now to the defect log analyzer 220 of the defect navigator system 200, as used in the Program Blackout During Live Broadcast, the defect log analyzer 220 monitors incoming logs from the backend services, and identifying playback failure events specifically tied to the blacked-out program. Additionally, the defect log analyzer 220 stores this information regarding the blacked-out program for further analysis, and tagging logs related to this specific blackout incident. Generally speaking, the defect log analyzer 220 is used in the Program Blackout During Live Broadcast to monitor incoming logs, detect playback failures due to blackout, perform log tagging, store blackout failure logs, and maintain the session wise logging information in the database 280.

Referring now to the defect use case identifier 230 of the defect navigator system 200, as used in the Program Blackout During Live Broadcast, the defect use case identifier 230 analyzes the logs captured by the defect log analyzer 220 to identify patterns and correlations between users who experienced the playback failure tied to the blacked-out program. Next, the defect use case identifier 230 segregates users based on attributes such as one or more of zip code/DMA, type of channel (e.g., sports, news), type of errors encountered, type of user account (e.g., active/paid or free users), and the subscribed package details. Additionally, the defect use case identifier 230 uses Root Cause Analysis (RCA) to determine that the failure issue is tied to the blackout of a specific program in certain zip codes. Furthermore, the defect use case identifier 230 concludes that the blackout is causing the failure only for users within the affected zip codes who are trying to access the program.

Referring now to the defect similar user set system 240 of the defect navigator system 200, as used in the Program Blackout During Live Broadcast, the defect similar user set system 240 identifies other users who are likely to be affected by the same blackout conditions, based on the analysis from the defect use case identifier 230. Additionally, the defect similar user set system 240 groups these users into a similar user set, focusing on those within the same zip codes or DMAs who might attempt to access the blacked-out program. Furthermore, the defect similar user set system 240 prepares this user group for targeted logging and analysis to monitor for further failures with respect to blackout assets.

Referring now to the defect log level controller 250 of the defect navigator system 200, as used in the Program Blackout During Live Broadcast, the defect log level controller 250 adjusts the logging levels for the identified similar user set, increasing the detail of logs (e.g., enabling debug or info level logs) for users within the zip codes affected by the same blackout conditions. Additionally, the defect log level controller 250 ensures that the logging for these users captures additional context, such as the decision-making process around the blackout and any subsequent playback attempts. Furthermore, the defect log level controller 250 continues to monitor the logs, adjusting log levels dynamically based on ongoing analysis and the emergence of new issues relating to the blackout conditions.

Referring now to the defect learning period manager 260 of the defect navigator system 200, as used in the Program Blackout During Live Broadcast, the defect learning period manager 260 manages the entire logging process during the blackout period, and initiates a learning phase where the system gathers detailed logs to understand the impact and root cause. Additionally, the defect learning period manager 260 examines the duration of this logging phase, and ensures that sufficient data is collected to analyze the blackout issue effectively. Furthermore, the defect learning period manager 260 manages phases where the defect navigator system 200 adapts its logging strategy based on real-time data, thereby ensuring that log levels are optimally configured for effective analysis of the blackout conditions. Once enough information has been gathered and the defect navigator system 200 has adapted to the situation, the defect learning period manager 260 determines when to reset the logging levels back to their standard configuration, thereby reducing unnecessary logging and resource use. In this manner, the defect learning period manager 260 incorporates the insights gained during the blackout incident into the system’s ongoing learning, ensuring that future blackouts are managed more efficiently.

Referring now to the dynamic configuration setter log level filter 270 of the defect navigator system 200, as used in the Program Blackout During Live Broadcast, the dynamic configuration setter log level filter 270 controls the dynamic logger configuration to handle the logging levels at run time with respect to the blackout conditions. In this scenario, the defect navigator system 200 effectively identifies and manages a program blackout event in a live broadcast. Each component of the system plays a specific role in capturing, analyzing, and responding to the incident, ensuring that future blackout condition occurrences are handled more smoothly and with minimized impact on users.

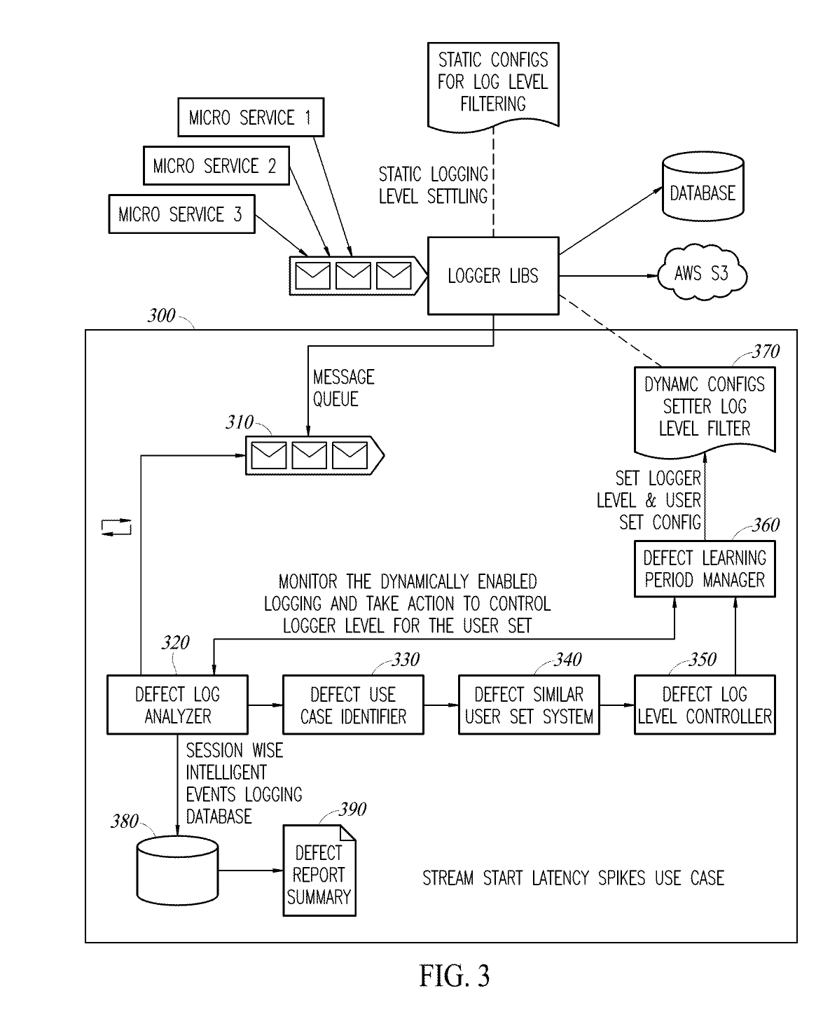

As shown in FIG. 3, in some embodiments the defect navigator system 300 is used to address the scenario of Stream Start Latency Spikes. In some embodiments, there are recurring spikes in stream start latency that occur a few times a day or on specific times in a day (e.g., peak hours, top of the hour) for a specific duration. This issue affects system performance, particularly for systems in certain regions, systems trying specific content, playback from specific screens, or playback under specific conditions. This leads to various problematic experience for users, as well as burden on the system network. The operations and workflow of each system component are discussed below.

Referring now to the defect log analyzer 320 of the defect navigator system 300, as used in the Stream Start Latency Spikes, the defect log analyzer 320 monitors logs in real time and captures instances where the system causes delays or failures related to starting video streams. Additionally, the defect log analyzer 320 tags logs associated with these latency spikes for further analysis. Furthermore, the defect log analyzer 320 focuses on recurring patterns within these latency spikes.

Referring now to the defect use case identifier 330 of the defect navigator system 300, as used in the Stream Start Latency Spikes, the defect use case identifier 330 analyzes the logs captured to identify any correlations between the latency spikes and specific user characteristics, such as one or more of user account type (e.g., active/paid or free users), client platform information, details about the API calls made during the latency spike, geographic location and regional distribution of users affected by the latency spike, types of API calls made during the latency events, users adaptive streaming or network throttling history, backend services load that point of time (e.g., top of the hours or peak time load issue), and any third party involvement (e.g., few channel transcoded streams are directly consumed from 3rd party vendors in live events, such as ESPN). Additionally, the defect use case identifier 330 determines whether certain APIs or services are consistently involved in the latency spikes. Furthermore, the defect use case identifier 330 narrows down the issue to a particular API and identifies users impacted by this specific latency cause if a pattern is identified (e.g., a specific API, like the DVR listing API, is causing the latency).

Referring now to the defect similar user set system 340 of the defect navigator system 300, as used in the Stream Start Latency Spikes, the defect similar user set system 340 groups users who are likely to experience similar latency issues, based on the findings from the defect use case identifier 330. The defect similar user set system 340 determines these user groups using the identified problematic API or those in the same regions. Additionally, the defect similar user set system 340 creates a user set for targeted monitoring, particularly during the identified times when latency spikes are most likely to occur. Furthermore, the defect similar user set system 340 prepares this user group for more detailed logging and further analysis to prevent future latency spikes.

Referring now to the defect log level controller 350 of the defect navigator system 300, as used in the Stream Start Latency Spikes, the defect log level controller 350 adjusts logging levels specifically for the identified similar user set, increasing log detail (e.g., debug or info level) during the times when latency spikes are expected. Additionally, the defect log level controller 350 ensures detailed capture of API performance, user interactions, and system behavior during these critical latency periods. Furthermore, in some embodiments the defect log level controller 350 continuously monitors the latency spike conditions, and dynamically adjusts log levels as needed, based on the evolving understanding of the latency spike issue.

Referring now to the defect learning period manager 360 of the defect navigator system 300, as used in the Stream Start Latency Spikes, the defect learning period manager 360 initiates a learning phase to collect detailed logs during the periods of recurring latency spikes. Additionally, the defect learning period manager 360 logs over multiple occurrences of the latency issue, and enables the defect navigator system 300 to refine its understanding of the root cause of the latency spikes and the affected user set. Furthermore, in some embodiments the defect learning period manager 360 determines when enough data has been collected to address the latency issue, and then resets log levels to normal once the learning objectives are met regarding the latency spike issue. The defect learning period manager 360 integrates these findings into a long-term optimization strategy to preempt similar latency spike issues in the future. In this scenario, the defect navigator system 300 effectively tackles stream start latency spikes by identifying patterns, adjusting logging dynamically, and learning from the incidents to enhance future performance and user experience.

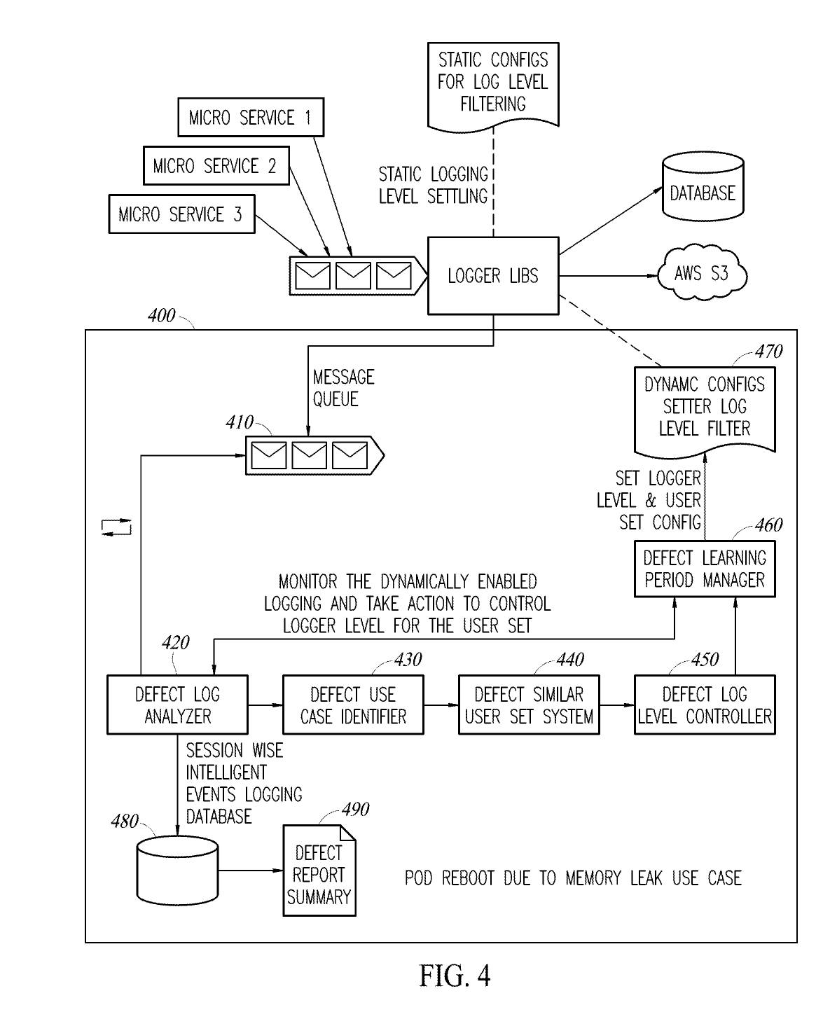

As shown in FIG. 4, in some embodiments the defect navigator system 400 is used to address the scenario of Pod Reboot Due to Memory Leak. In such an embodiment, the defect navigator system 400 is used for infrastructure related issues. One such infrastructure related issue is described below. In some implementations, pods within a distributed system may experience inconsistent reboots, potentially due to a memory leak over a period of time. Each time a pod reboots, the system needs to capture detailed information to identify the pod reboots cause and prevent future pod reboots occurrences. The operations and workflow of each system component are discussed below.

Referring now to the defect log analyzer 420 of the defect navigator system 400, as used in the Pod Reboot Due to Memory Leak, the defect log analyzer 420 continuously monitors logs from the pods, and focuses on events related to pod crashes or reboots. Additionally, the defect log analyzer 420 tags logs associated with these pod reboots for further analysis. Furthermore, the defect log analyzer 420 identifies potential correlations with resource consumption and specific API interactions.

Referring now to the defect use case identifier 430 of the defect navigator system 400, as used in the Pod Reboot Due to Memory Leak, the defect use case identifier 430 analyzes the collected logs to identify any patterns in the pod reboots, such as one or more of the memory and CPU usage at the time of the reboot, API calls made just before the reboot, the frequency and pattern of reboots over time, consistent increases in memory usage prior to each reboot, specific APIs or processes that are frequently involved in the lead-up to a reboot, and correlations between reboot incidents and system load or other environmental factors. Additionally, the defect use case identifier 430 has infrastructure attribute access (e.g., observability tools such as Prometheus) to analyze the infrastructure related parameters. Furthermore, the defect use case identifier 430 uses Root Cause Analysis (RCA) to identify patterns of memory leaks associated with specific APIs or workloads. In some embodiments, the defect use case identifier 430 may conclude that the reboots are likely due to a memory leak triggered by specific API calls or resource usage patterns.

Referring now to the defect similar user set system 440 of the defect navigator system 400, as used in the Pod Reboot Due to Memory Leak, the defect similar user set system 440 identifies other pods or services within the system that might be vulnerable to the same memory leak issue based on similar API usage patterns or resource consumption profiles. Additionally, the defect similar user set system 440 groups these pods or services into a similar set for closer monitoring and analysis. In this manner, the defect similar user set system 440 focuses on preventing similar reboots. Furthermore, the defect similar user set system 440 prepares this user group for targeted logging and monitoring to better mitigate the risk of memory leaks.

Referring now to the defect log level controller 450 of the defect navigator system 400, as used in the Pod Reboot Due to Memory Leak, the defect log level controller 450 adjusts the logging levels for the identified similar set of pods or services. In some embodiments, the defect log level controller 450 increases detail around memory usage, API calls, and system behavior leading up to a reboot. Additionally, the defect log level controller 450 ensures that the logs capture the necessary details to diagnose and prevent future memory leaks. Furthermore, in some embodiments the defect log level controller 450 continuously monitors the pod reboot conditions, and dynamically adjusts log levels as needed, based on the evolving understanding of the pod reboot issue.

Referring now to the defect learning period manager 460 of the defect navigator system 400, as used in the Pod Reboot Due to Memory Leak, the defect learning period manager 460 initiates a learning phase where the system collects detailed logs during pod reboots, focusing on memory and CPU metrics, as well as API usage. Additionally, the defect learning period manager 460 examines this data over multiple reboots, and enables the defect navigator system 400 to build a comprehensive understanding of the memory leak issue. Furthermore, in some embodiments the defect learning period manager 460 determines when enough data has been collected to address the pod reboot issue, and then resets log levels to normal once the learning objectives are met to conserve resources while maintaining critical monitoring. The defect learning period manager 460 integrates these findings into a long-term logging and optimization strategy to preempt similar pod reboot issues in the future. In this scenario, the defect navigator system 400 effectively identifies and mitigates the impact of memory leaks causing pod reboots. Each component of the defect navigator system 400 plays a critical role in capturing detailed logs, analyzing patterns, and adjusting the system’s behavior to ensure stability and reliability.

In some embodiments, the defect navigator system is further enhanced by integrating access to various databases, microservice APIs, and the codebase itself. By leveraging these additional resources, the defect navigator system deepens its defect analysis capabilities and provides more precise root cause identification. In one such embodiment, where the defect navigator system has access to a codebase, the system analyzes recent code changes to identify potential sources of new defects. Additionally, by querying microservice APIs, the defect navigator system gathers real-time data on service interactions and dependencies. In such an embodiment, the defect navigator system provides a comprehensive analysis that not only identifies the defect but also suggests potential solutions, such as rolling back a specific service update or adjusting API rate limits to mitigate identified issues. This expanded access enables the defect navigator system to evolve into an even more powerful tool for continuous improvement and proactive defect management in complex cloud-native environments.

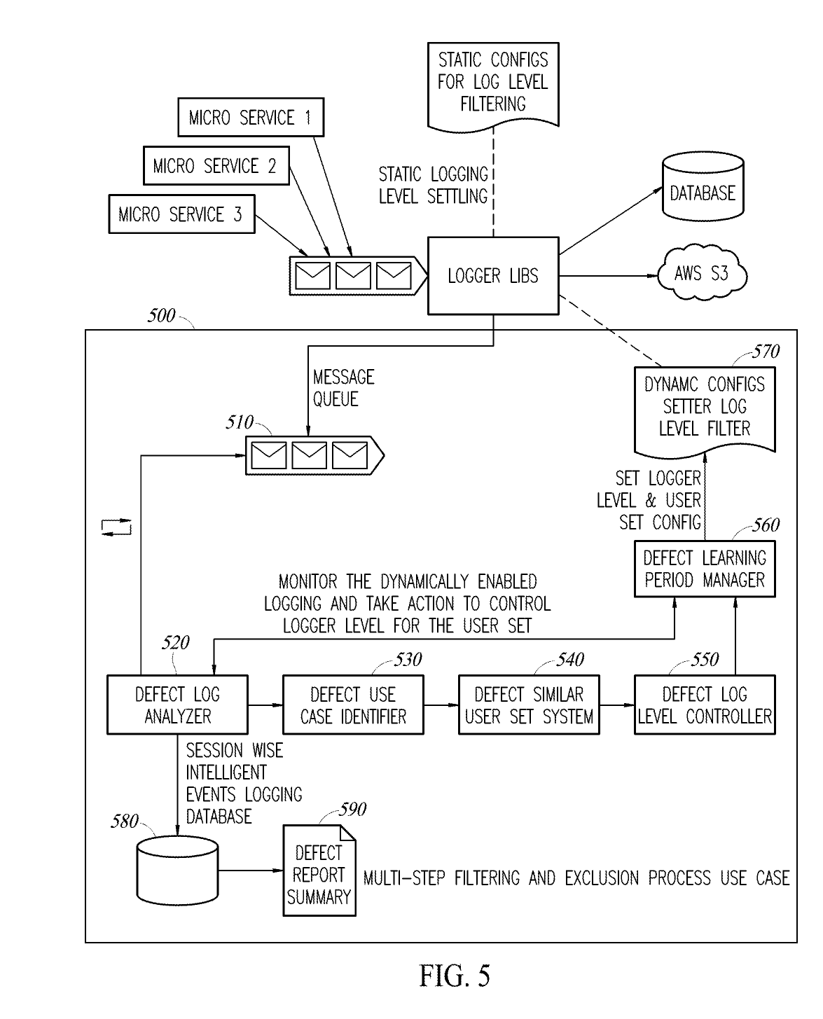

As shown in FIG. 5, in some embodiments the defect navigator system is used to address the scenario of Multi-Step Filtering and Exclusion Process. An example of the Multi-Step Filtering and Exclusion Process is described below. In one such embodiment, the defect navigator system identifies an initial correlation that playback failures are more frequent in a specific zip code. The system then applies a filter to exclude users outside that zip code, recalculates the correlation, and finds that the issue is more pronounced among paid users. Next, the system initiates further filtering that excludes free users, which may reveal that the problem persists for a particular channel. Additionally, the system calculates the conditional probability that the failure is linked to the combination of being a paid user, in the specific zip code, and watching the specific channel. Furthermore, the system concludes that this exact combination is the root cause, thereby instructing targeted interventions and mitigations. The operations and workflow of each system component are discussed below.

Referring now to the initial data collection and preprocessing system 520 of the defect navigator system 500, as used in the Multi-Step Filtering and Exclusion Process, the initial data collection and preprocessing system 520 begins by gathering raw log data captured by the system. This raw log data includes all relevant logs during the failure events, encompassing user data, system metrics, and metadata. Additionally, the initial data collection and preprocessing system 520 preprocesses the data to standardize formats, filter out irrelevant logs, and organize the data into structured sets. Such structured sets may include user attributes, system metrics, and metadata.

Referring now to the multi-dimensional correlation analyzer 530 of the defect navigator system 500, as used in the Multi-Step Filtering and Exclusion Process, the multi-dimensional correlation analyzer 530 creates an initial correlation matrix that maps all potential relationships between user attributes (e.g., paid/free, location), system metrics (e.g., CPU, memory usage), and metadata (e.g., program, API). The initial correlation matrix identifies potential correlations between these factors and the failure events by calculating correlation coefficients. Additionally, the multi-dimensional correlation analyzer 530 generates an initial hypotheses regarding which factors might be contributing to the failure based on the correlation matrix. Furthermore, the multi-dimensional correlation analyzer 530 tests each hypothesis by applying filters to the data set, isolating users, system metrics, or metadata that match the hypothesized conditions (e.g., only include logs from paid users in a specific zip code watching a specific channel).

Referring now to the iterative filtering and exclusion system 540 of the defect navigator system 500, as used in the Multi-Step Filtering and Exclusion Process, the iterative filtering and exclusion system 540 applies a first set of filters based on the most strongly correlated factors identified in the hypothesis testing phase (e.g., exclude all users outside the affected zip code). The system then recalculates the correlations on the reduced data set to see if the relationship strengthens or weakens. Additionally, the iterative filtering and exclusion system 540 performs iterative exclusion by identifying the next most correlated factor (e.g., whether the user is paid or free), applying the filter to exclude irrelevant logs (e.g., exclude free users if the issue is strongly associated with paid users), and recalculating correlations to refine the focus further. Furthermore, the iterative filtering and exclusion system 540 performs multi-factor isolation by continuing to refine the data set through iterative exclusion until a minimal set of conditions remains, which still correlates strongly with the failure event (e.g., the issue is identified as affecting only paid users in a specific zip code watching a specific channel).

Referring now to the conditional probability analyzer 550 of the defect navigator system 500, as used in the Multi-Step Filtering and Exclusion Process, the conditional probability analyzer 550 performs a final hypothesis testing with the narrowed data set by using conditional probability analysis to determine the likelihood that the remaining factors are responsible for the failure. Additionally, the conditional probability analyzer 550 performs confidence scoring by assigning confidence scores to each identified condition based on the conditional probability results. Higher scores indicate a stronger likelihood that the condition is responsible for the failure

Referring now to the root cause determination system 560 of the defect navigator system 500, as used in the Multi-Step Filtering and Exclusion Process, the root cause determination system 560 determines if any factors still show weaker correlation or lower confidence scores, and excludes any such factors to further refine the conditions. Additionally, the root cause determination system 560 determines output final conditions by ultimately outputting the most likely conditions causing the failure, and providing a concise set of failure conditions (e.g., the issue occurs exclusively for (1) paid users, (2) in zip code X, (3) watching channel Y). Furthermore, in some embodiments the root cause determination system 560 creates a feedback loop by incorporating the identified root cause conditions into the system’s dynamic log management and alerting processes to prevent future occurrences.

The root cause determination system 560 also includes an automated reporting and feedback loop that automatically generates detailed reports (e.g., Jira tickets), that include comprehensive information on the issue, use case, logs, and statistical summaries (e.g., number of affected users and potential future impact). In some embodiments, engineering feedback is also integrated into the learning module to enhance future predictions and analysis.

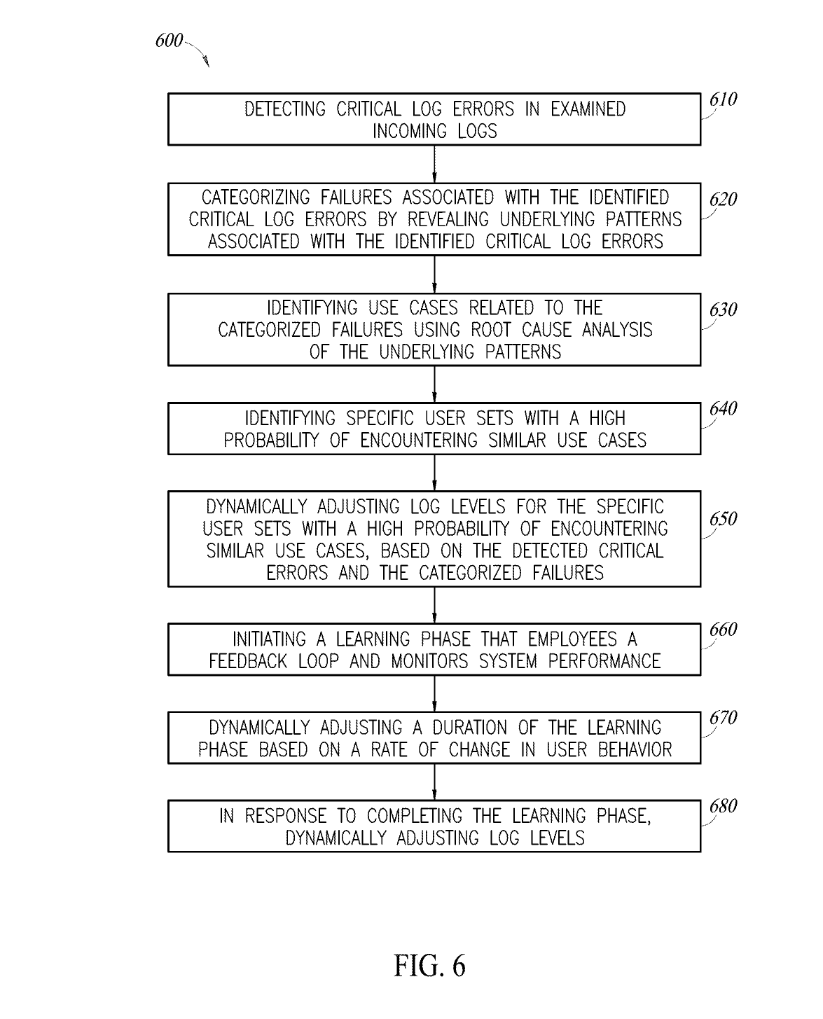

FIG. 6 is a logic diagram showing a method for defect navigation in a logging system for distributed cloud-native development. This method may be implemented by a 5G architecture, as has been shown in FIGS. 1-5, as described above. As shown in FIG. 6, at operation 610, the method includes detecting critical log errors in examined incoming logs. At operation 620, the method includes categorizing failures associated with the detected critical log errors by revealing underlying patterns associated with the detected critical log errors. At operation 630, the method includes identifying use cases related to the categorized failures using root cause analysis of the underlying patterns. At operation 640, the method includes identifying specific user sets with a high probability of encountering other use cases that correlate with the identified use cases. At operation 650, the method includes dynamically adjusting log levels for the specific user sets with a high probability of encountering the other use cases, based on the detected critical errors and the categorized failures. At operation 660, the method includes initiating a learning phase that employs a feedback loop and monitors system performance. At operation 670, the method includes dynamically adjusting a duration of the learning phase based on a rate of change in user behavior. At operation 680, the method includes, in response to completing the learning phase, dynamically adjusting log levels.

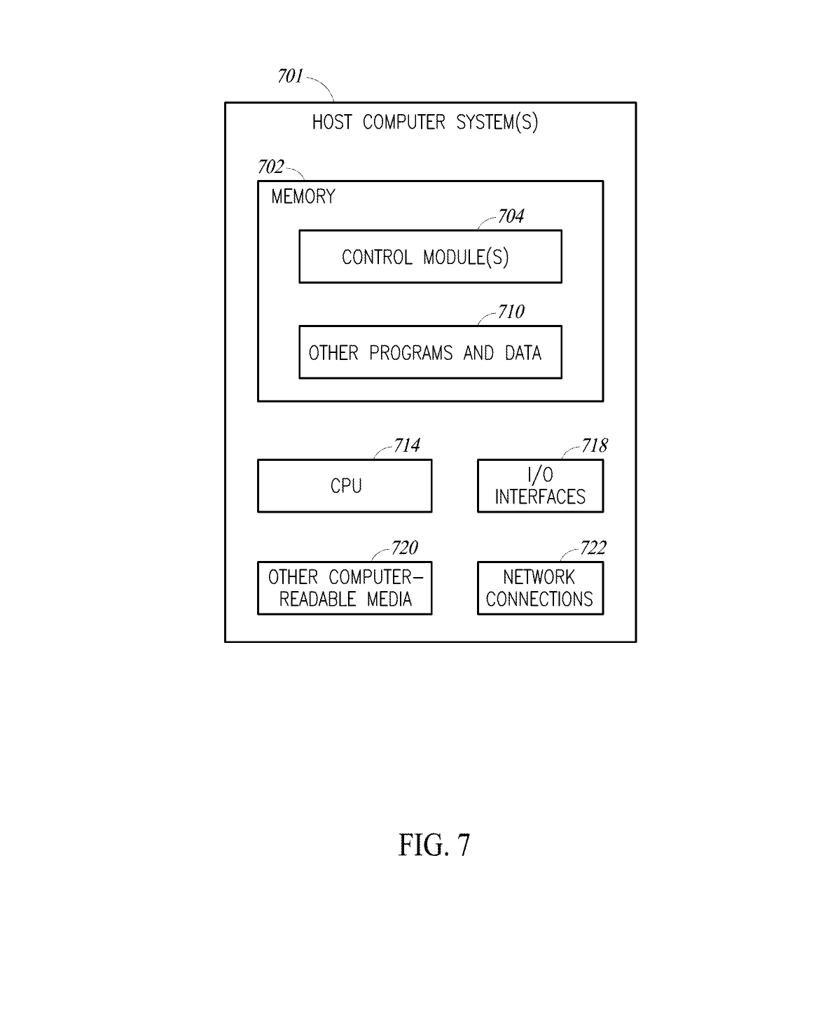

FIG. 7 shows a system diagram that describes an example implementation of a computing system(s) for implementing embodiments described herein. The functionality described herein for a method for defect navigation in a logging system for distributed cloud-native development. In some embodiments, such functionality may be completely software-based and designed as cloud-native, meaning that they’re agnostic to the underlying cloud infrastructure, allowing higher deployment agility and flexibility. This defect navigation system may be implemented in a cloud-based architecture, as has been shown in FIGS. 1-7, as described above.

In particular, shown is example host computer system(s) 701. For example, such computer system(s) 701 may represent those in various data centers and gNBs shown and/or described herein that host the functions, components, microservices and other aspects described herein to implement a method for defect navigation in a logging system for distributed cloud-native development. In some embodiments, this system is extended to any use case and any application that has the capability to push or store the logs in the cloud. Additionally, in other embodiments, similar system are implemented in one or more standalone applications that generates logs.

In some embodiments, one or more special-purpose computing systems may be used to implement the functionality described herein. Accordingly, various embodiments described herein may be implemented in software, hardware, firmware, or in some combination thereof. Host computer system(s) 701 may include memory 702, one or more central processing units (CPUs) 714, I/O interfaces 718, other computer-readable media 720, and network connections 722.

Memory 702 may include one or more various types of non-volatile and/or volatile storage technologies. Examples of memory 702 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 702 may be utilized to store information, including computer-readable instructions that are utilized by CPU 714 to perform actions, including those of embodiments described herein.

Memory 702 may have stored thereon control module(s) 704. The control module(s) 704 may be configured to implement and/or perform some or all of the functions of the systems, components and modules described herein for a method for defect navigation in a logging system for distributed cloud-native development. Memory 702 may also store other programs and data 710, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, and the like.

Network connections 722 are configured to communicate with other computing devices to facilitate the functionality described herein. In various embodiments, the network connections 722 include transmitters and receivers (not illustrated), cellular telecommunication network equipment and interfaces, networks of all types (including cloud native networks), and/or other computer network equipment and interfaces to send and receive data as described herein, such as to send and receive instructions, commands and data to implement the processes described herein. I/O interfaces 718 may include a video interface, other data input or output interfaces, or the like. Other computer-readable media 720 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
continuously examining, via a defect log analyzer, incoming logs to detect anomalies and failures based on predefined and dynamically learned markers;
detecting, via the defect log analyzer, critical log errors in the examined incoming logs that affect system performance;
categorizing failures associated with the detected critical log errors, via a defect use case identifier, by revealing underlying patterns associated with the detected critical log errors;
identifying, via the defect use case identifier, use cases related to the categorized failures using root cause analysis of the underlying patterns, wherein the use cases are associated with user sets;
identifying, via a defect similar user set system, specific user sets with a high probability of encountering other use cases that correlate with the identified use cases;
dynamically adjusting, via a defect log level controller, log levels for the specific user sets with the high probability of encountering the other use cases, based on the detected critical log errors and the categorized failures;
in response to identified failure use cases, initiating a learning phase during which a trained understanding of user behavior is refined by the logging system using a feedback loop that monitors system performance;
dynamically adjusting, via a defect learning period manager, a duration of the learning phase based on a rate of change in user behavior; and
in response to accumulating a predetermined volume of user logs across log levels and completing the learning phase, dynamically adjusting log levels to refine system configuration, minimize resource usage by targeting the specific user sets for more detailed logging and analysis, and retain critical log information for effective debugging and system monitoring.

2. The method of claim 1, wherein the defect log analyzer logs critical events that capture insights and stores the critical events in a database.

3. The method of claim 2, wherein the stored critical events are used to generate a defect summary report that provides detailed characteristics and associated intelligent events for in-depth automatic bug analysis.

4. The method of claim 1, further comprising: strategically enabling detailed logging for specific user sets and temporal intervals.

5. The method of claim 1, further comprising: using cloud-native logging to provide scalable and adaptive solutions for log management in distributed environments.

6. The method of claim 1, wherein the dynamically adjusted log levels provide resource automatized logging.

7. The method of claim 1, wherein the defect log analyzer captures detailed information about specific errors encountered by different users.

8. The method of claim 1, wherein the defect use case identifier segregates users based on one or more attributes including user type, location, channel type, and error type.

9. The method of claim 1, wherein the defect learning period manager examines feedback on use case predictions and uses the feedback to refine and improve prediction algorithms.

10. A system comprising:
one or more processors; and
a memory device storing a set of instructions that, when executed by the one or more processors, causes the one or more processors to:
detect critical log errors in examined incoming logs that affect system performance;
categorize failures associated with the detected critical log errors by revealing underlying patterns associated with the detected critical log errors;
identify use cases related to the categorized failures using root cause analysis of the underlying patterns, wherein the use cases are associated with user sets;
identify specific user sets with a high probability of encountering other use cases that correlate with the identified use cases;
dynamically adjust log levels for the specific user sets with the high probability of encountering the other use cases, based on the detected critical errors and the categorized failures;
in response to identified failure use cases, initiate a learning phase that includes training on user behavior and use a feedback loop that monitors system performance;
dynamically adjust a duration of the learning phase based on a rate of change in user behavior; and
in response to completing the learning phase, dynamically adjust log levels to refine system configuration.

11. The system of claim 10, wherein the system logs critical events that capture insights and stores the critical events in a database.

12. The system of claim 10, wherein the stored critical events are used to generate a defect summary report that provides detailed characteristics and associated intelligent events for in-depth automatic bug analysis.

13. The system of claim 10, wherein the system strategically enables detailed logging for specific user sets and temporal intervals.

14. The system of claim 10, wherein the system uses cloud-native logging to provide scalable and adaptive solutions for log management in distributed environments.

15. The system of claim 10, wherein the system dynamically adjusts log levels to provide resource automatized logging.

16. The system of claim 10, wherein the system captures detailed information about specific errors encountered by different users.

17. The system of claim 10, wherein the system segregates users based on one or more attributes including user type, location, channel type, and error type.

18. The system of claim 10, wherein the system examines feedback on use case predictions and uses the feedback to refine and improve prediction algorithms.

19. A method of defect navigation of a logging system, the method comprising:
detecting critical log errors in examined incoming logs that affect system performance;
categorizing failures associated with the detected critical log errors by revealing underlying patterns associated with the detected critical log errors;
identifying use cases related to the categorized failures using root cause analysis of the underlying patterns, wherein the use cases are associated with user sets;
identifying specific user sets with a high probability of encountering other use cases that correlate with the identified use cases;
dynamically adjusting log levels for the specific user sets with a high probability of encountering the other use cases, based on the detected critical errors and the categorized failures;
initiating a learning phase that employs a feedback loop and monitors system performance;
dynamically adjusting a duration of the learning phase based on a rate of change in user behavior; and
in response to completing the learning phase, dynamically adjusting log levels.
